(19) United States
(12) Patent Application Publication
(10) Pub. No.: US 2010/0040431 A1
(43) Pub. Date: Feb. 18, 2010

(54) BOLT ROTATION PREVENTION STRUCTURE

(75) Inventor: Tatsuo SUZUKI, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Mie (JP)

(21) Appl. No.: 12/402,741

(22) Filed: Mar. 12, 2009

(30) Foreign Application Priority Data
Aug. 18, 2008 (JP) 2008-210094

(51) Int. Cl. F16B 39/00

(52) U.S. Cl. 411/166

(57) ABSTRACT

Rotation of a bolt is prevented when a nut is screwed onto a threaded shaft portion of the bolt while a head portion of the bolt is fitted to a receiving portion formed on a fixed member. The head portion of the bolt has a shape of a polygon, an ellipse or an oblong. At least one of an end surface and a periphery surface of the head portion of the bolt has an anti-rotation protruding portion formed thereon. A positioning recess is formed on an inner surface of the receiving portion for receiving the anti-rotation protruding portion. The head portion of the bolt is fitted to the receiving portion to prevent the bolt from rotating when the nut is screwed onto the threaded shaft portion.

### CROSS-REFERENCE TO RELATED APPLICATIONS

The present application claims priority under 35 U.S.C. §119 of Japanese Application No. 2008-210094, filed on Aug. 18, 2008, the disclosure of which is expressly incorporated by reference herein in its entirety.

### BACKGROUND OF THE INVENTION

1. Field of the Invention

The present invention relates to a bolt rotation prevention structure, and more specifically, relates to a bolt rotation prevention structure for preventing rotation of a bolt when a nut is screwed onto a threaded shaft portion of the bolt while a head portion of the bolt is fixed to a fixed member.

2. Description of Related Art

FIG. 10 shows an electrical junction box having a conventional bolt rotation prevention structure (see Related Art 1). In the electrical junction box 1, a head portion 4a of a bolt 4 is fixedly press-fitted to a bolt receiving portion 3 formed as a concave region on an upper surface of a plastic case 2. An LA terminal 5 and a bus bar 6 become connected in between the bolt 4 and a nut (not shown in the figure).

In the electrical junction box 1, the head portion 4a of the bolt 4 has a shape of a quadrangle, and the bolt receiving portion 3 also has a shape of a quadrangle, corresponding to the shape of the head portion 4a, thereby preventing rotation of the bolt 4 when the nut is screwed thereonto.

However, as in the electrical junction box 1, when the case 2 that fixedly retains the head portion 4a of the bolt 4 is plastic while the bolt 4 is metallic, the inner surface of the bolt receiving portion 3 of the case 2 may be scraped by a rotational force applied to the head portion 4a when the nut is screwed onto the bolt 4. As a result, it is possible that the bolt receiving portion 3 becomes bigger and unable to prevent rotation of the bolt 4. In particular, when a bolt fastening jig is used to screw the nut, it is easy to apply an excessive rotational force to the bolt 4 when the nut is screwed thereonto, and it is possible that the bolt receiving portion 3 is scraped.

[Related Art 1] Japanese Utility Model Publication H3-62474

### SUMMARY OF THE INVENTION

The present invention is provided to resolve the above-described problems. An object of the present invention is to provide a bolt rotation prevention structure capable of surely preventing rotation of a bolt when a nut is screwed onto a threaded shaft portion of the bolt while a head portion of the bolt is fixedly retained to a fixed member.

To achieve the above objective, the present invention provides a bolt rotation prevention structure that includes a head portion of a bolt and a receiving portion for receiving the head portion of the bolt. The head portion of the bolt has a shape of a polygon, an ellipse or an oblong, and at least one of an end surface and a periphery surface of the head portion has an anti-rotation protruding portion formed on a region thereof. The receiving portion is formed on a fixed member and has a positioning recess formed on an inner surface thereof for receiving the anti-rotation protruding portion. The head portion of the bolt is fitted to the receiving portion to prevent the bolt from rotating when a nut is screwed onto a threaded shaft portion of the bolt.

The fixed member is a case of an electrical junction box, and is made of plastic. The head portion of the bolt is fixedly retained to the case, making the threaded shaft portion protruding. Parts installed on the case are fixedly retained in between the head portion of the bolt and the nut. The head portion has a shape of a quadrangle. The anti-rotation protruding portion formed on the head portion is a linear protruding portion that is formed on the end surface of the head portion and extends from one side to an opposite side of the head portion or a protruding portion that is formed on at least opposing sides of the periphery surface of the head portion.

When there is not enough space for forming the positioning recess on a periphery of an opening of the receiving portion, it is preferred that the anti-rotation protruding portion be formed on the end surface of the head portion of the bolt. When there is not enough space for forming the positioning recess on a bottom of the receiving portion, it is preferred that the anti-rotation protruding portion be formed on the periphery surface of the head portion of the bolt.

Examples of the electrical junction box include an electrical junction box that connects to a wire harness installed in a car. Examples of the parts that are fixedly retained in between the head portion of the bolt and the nut include a bus bar that connects to an internal circuit of an electrical junction box and a terminal of a power wire. The receiving portion may be formed on a horizontal wall or a vertical wall of a case of an electrical junction box.

It is preferred that a protruding height of the anti-rotation protruding portion from the end surface of the head portion of the bolt is 0.1 mm or more and 10 mm or less. This is because a protruding height less than 0.1 mm is too low for the anti-rotation protruding portion to exhibit sufficient anti-rotation capability, and when the protruding height is more than 10 mm, bolt material strength decreases. Further, it is desirable that the protruding height is 0.3 mm or more and 8 mm or less, and in particular, 0.5 mm or more and 5 mm or less.

When the shape of the head portion of the bolt is an ellipse or an oblong, it is desirable that the protruding portion is formed on the end surface of the head portion extending along a major axis direction or on opposing sides of the periphery surface of the head portion along the major axis direction. This allows applying an anti-rotation force to the two ends of the major axis that are most distant from the threaded shaft portion of the bolt, thereby allowing effective bolt rotation prevention.

As described above, according to the bolt rotation prevention structure of the present invention, in addition to making a head portion of a bolt a polygon, an ellipse or an oblong, an anti-rotation protruding portion protruding from the head portion of the bolt is fitted to a positioning recess formed on an inner surface of a receiving portion of a fixed member, thereby allowing double bolt rotation prevention. Consequently, the bolt is surely prevented from rotating even when a rotational force is applied when a nut is screwed onto the bolt.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a plain view of a case of an electrical junction box according to a first embodiment;

FIG. 2 is a perspective view of a bolt according to the first embodiment;

FIG. 3(a) is a perspective exploded view of a power wire connection portion illustrated in FIG. 1;

FIG. 3(b) is an explanatory cross-sectional exploded view of the power wire connection portion illustrated in FIG. 1;

FIG. 4 is an explanatory cross-sectional view of the power wire connection portion illustrated in FIG. 1;

FIG. 5 is a perspective view of a bolt and a receiving portion of a case according to a second embodiment;

FIG. 6 is a plain view illustrating a state that a head portion of the bolt shown in FIG. 5 is fixedly retained in the receiving portion of the case;

FIG. 7 illustrates a first different shape of a bolt according to the present invention;

FIG. 8 illustrates a second different shape of a bolt according to the present invention;

FIG. 9(a) is a perspective view illustrating a third different shape of a bolt according to the present invention;

FIG. 9(b) is a front view illustrating the third different shape of a bolt according to the present invention; and

FIG. 10 illustrates a prior art.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are explained in the following with reference to the drawings. In all of the embodiments, the present invention is directed to a structure for fixedly retaining a bolt 21 to a case 11 of an electrical junction box 10 installed in a car.

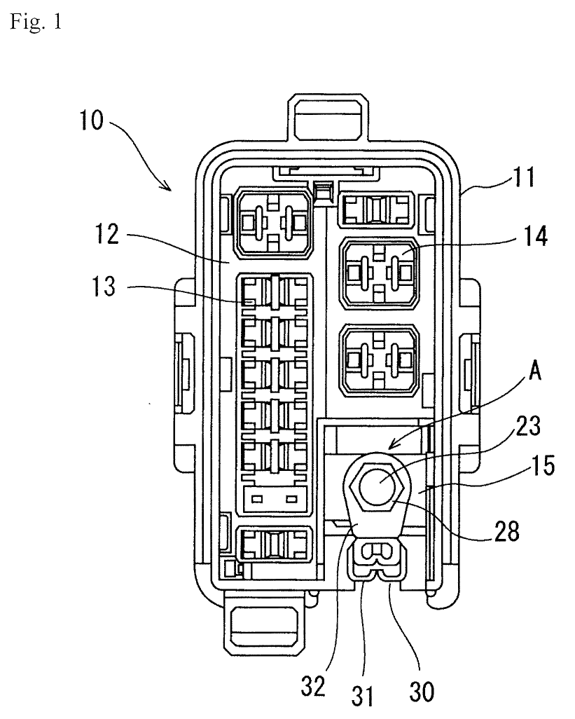

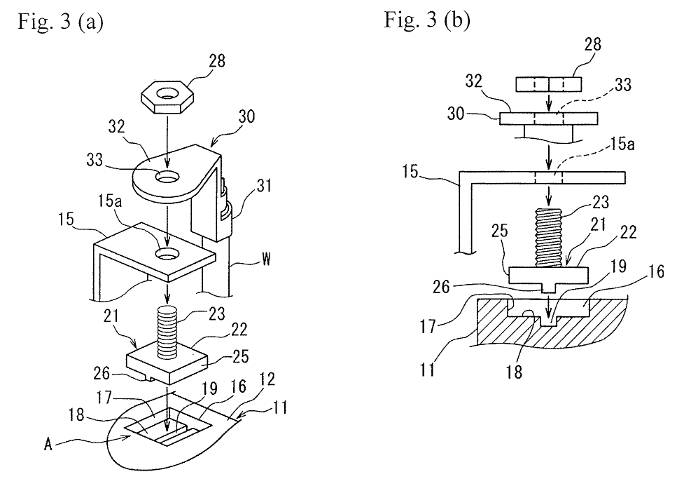

FIGS. 1-4 illustrate a bolt rotation prevention structure according to the first embodiment of the present invention. The case 11 of the electrical junction box 10 is plastic. As shown in FIG. 1, on an upper surface of a horizontal wall 12, a fuse housing 13 and a relay housing 14 are formed, along with a power wire connection portion A, which is formed at a corner. As shown in FIGS. 3(a) and 3(b), a circuit bus bar 15 contained inside the case 11 and a power wire W are fixedly retained by the bolt 21 and a nut 28. The upper surface and a lower surface of the case 11 are respectively covered by an upper cover and a lower cover (not shown in the figures), which are lock-coupled.

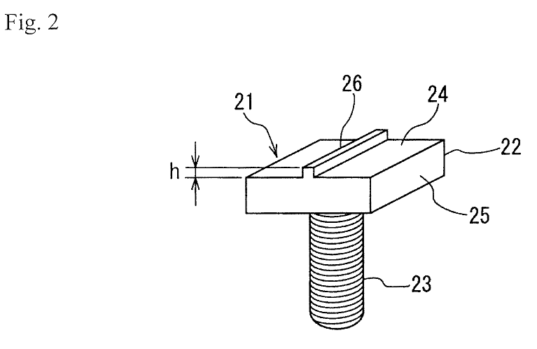

As shown in FIG. 2, the bolt 21 has a head portion 22, which has a shape of a quadrangle in a planar view, and a threaded shaft portion 23 protruding from the head portion 22. A linear anti-rotation protruding portion 26 is formed on an end surface 24 of the head portion 22, extending across the center of the quadrangle and connecting a pair of opposing sides. Protruding height h of the anti-rotation protruding portion 26, measured from the end surface 24 of the head portion 22, is 0.3 mm or more and 8 mm or less, and is 5 mm in the present embodiment.

An LA terminal 30, bent into an L-shape, is crimped onto an end of the power wire W. The LA terminal 30 has a wire crimp portion 31 and an electrical connection portion 32. The wire crimp portion 31 is formed in a vertical direction and the electrical connection portion 32 is formed on top of the wire crimp portion 31 and bends toward a horizontal direction. A bolt hole 33 is formed on the electrical connection portion 32.

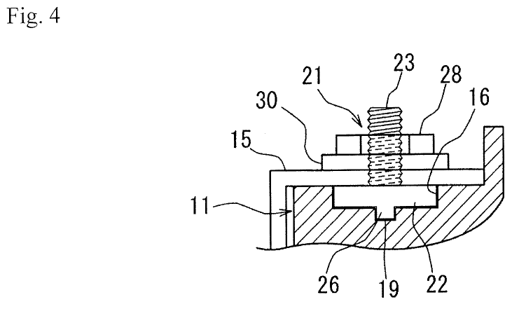

As shown in FIGS. 3(a) and 3(b), a concave receiving portion 16 is formed in the power wire connection portion A on the upper surface of the horizontal wall 12 for fixedly inserting thereto the head portion 22 of the bolt 21. As shown in FIG. 4, the head portion 22 of the bolt 21 is fixedly fitted into the receiving portion 16, making the threaded shaft portion 23 of the bolt 21 protruding upwardly. Specifically, the receiving portion 16 has a shape of a quadrangle in a planar view corresponding to the shape of the head portion 22 of the bolt 21, and a positioning recess 19 is formed on a bottom surface 18 of the receiving portion 16. An inner surface 17 of the receiving portion 16 is put in tight contact with a periphery surface 25 of the head portion 22 of the bolt 21, while the anti-rotation protruding portion 26 protruding from the head portion 22 is fitted in the positioning recess 19.

First, the threaded shaft portion 23 protruding from the bolt 21 is put through a bolt hole 15a that is formed on the circuit bus bar 15, the bolt 21 being fixedly fitted in the receiving portion 16 of the case 11. Next, the threaded shaft portion 23 is put through the bolt hole 33 of the LA terminal 30 so that the electrical connection portion 32 of the LA terminal 30 is placed on top of the circuit bus bar 15. Under this setting, the nut 28 is screwed onto the threaded shaft portion 23 from above, thereby fixedly retaining the LA terminal 30 and the circuit bus bar 15 onto the case 11, as shown in FIG. 4.

According to the above-described structure, in addition to bolt rotation prevention by fixedly fitting the quadrangle-shaped bolt head portion 22 to the quadrangle-shaped receiving portion 16, fitting the anti-rotation protruding portion 26 protruding from the bolt head portion 22 to the positioning recess 19 formed in the receiving portion 16 also allows bolt rotation prevention. This double bolt rotation prevention structure allows sure prevention of rotation of the bolt 21 when the nut 28 is screwed thereonto. Further, since the protruding height h from the end surface 24 of the head portion 22 is 0.3 mm or more and 8 mm or less, rotation prevention capability can be sufficiently realized.

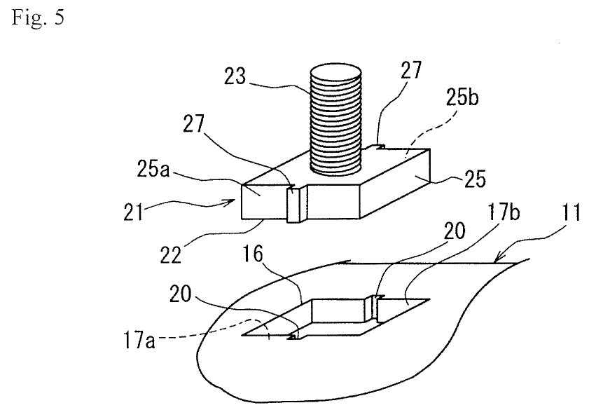

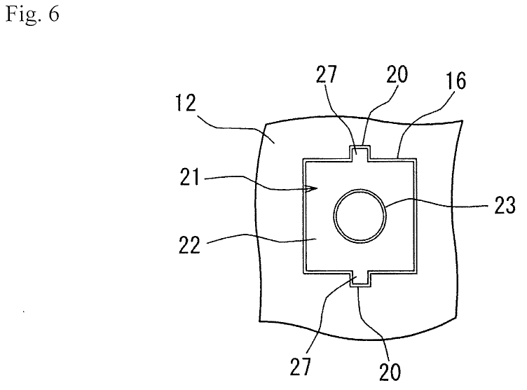

FIGS. 5 and 6 illustrate the second embodiment of the present invention. In the second embodiment, anti-rotation protruding portions 27 are formed on a pair of opposing periphery surfaces 25a and 25b of the quadrangle-shaped head portion 22 of the bolt 21. Each anti-rotation protruding portion 27 is formed as a strip-shaped protrusion extending along a direction parallel to the shaft line of the bolt 21. Positioning recesses 20 for receiving the anti-rotation protruding portions 27 are formed in a longitudinal direction on a pair of inner surfaces 17a and 17b on the inner surface 17 of the quadrangle-shaped receiving portion 16 of the case 11.

As shown in FIG. 6, the present embodiment also provides a double rotation prevention structure including bolt rotation prevention by making the bolt head portion 22 quadrangle-shaped and rotation prevention by fitting the anti-rotation protruding portions 27 to the positioning recesses 20, thereby allowing surer prevention of rotation of the bolt 21 when a nut is screwed thereonto.

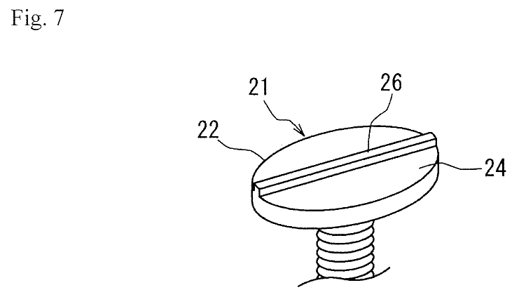

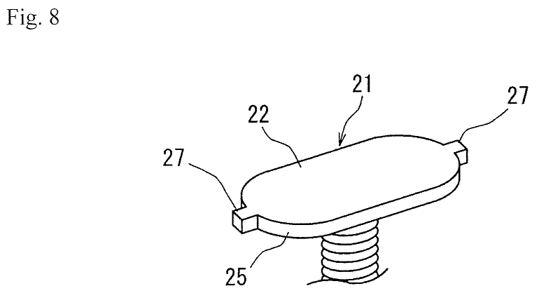

It is also possible to make the shape of the head portion 22 of the bolt 21 an ellipse as shown in FIG. 7 or an oblong as shown in FIG. 8. In either case, as shown in the figures, it is desirable that, when the anti-rotation protruding portion 26 is formed on the end surface 24 of the head portion 22, the anti-rotation protruding portion 26 is formed extending along a major axis direction, and when the anti-rotation protruding portions 27 are formed on the external periphery surface 25 of the head portion 22, the anti-rotation protruding portions 27 are formed at both ends of the major axis.

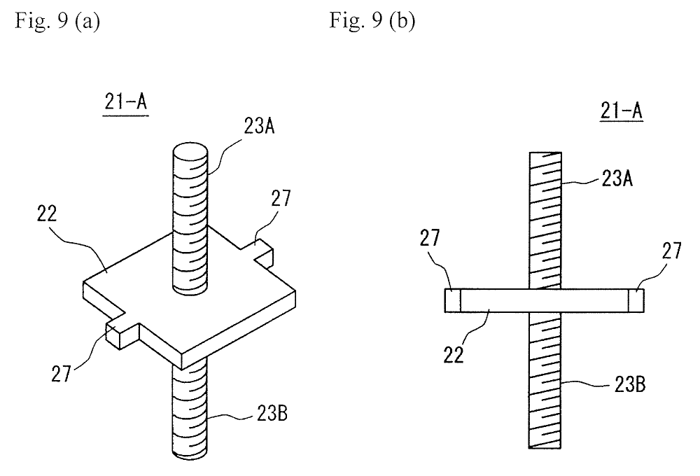

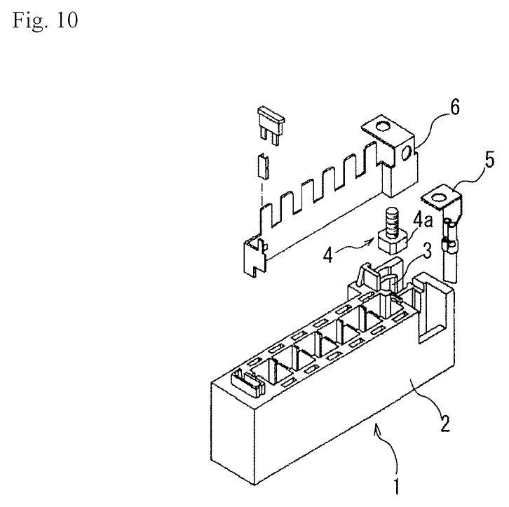

Further, as shown in FIGS. 9(a) and 9(b), even when a bolt 21-A is used that has a threaded shaft portion 23A and a threaded shaft portion 23B protruding respectively from upper and lower surfaces of a head portion 22 of the bolt 21-A, it is also possible to form anti-rotation protruding portions 27 on a pair of opposing periphery surfaces of the head portion 22.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

1. A bolt rotation prevention structure comprising:
a head portion of a bolt, the head portion having an rotation-prevention protruding portion provided on at least one of an end surface of the head portion and a peripheral surface of the head portion; and
a receiving portion configured to receive the head portion of the bolt, the receiving portion having a positioning recess provided on an inner surface thereof, the positioning recess being configured to receive the rotation-prevention protruding portion;
wherein the head portion of the bolt is fitted into the receiving portion such that the bolt is prevented from rotating while a nut is screwed onto a threaded shaft portion of the bolt.

2. The bolt rotation prevention structure according to claim 1, wherein
the receiving portion is provided on a case of an electrical junction box,
the head portion of the bolt is retained on the case in the receiving portion such that the threaded shaft portion protrudes,
parts installed on the case are fixedly retained between the head portion of the bolt and the nut screwed onto the threaded shaft portion, and
the rotation-prevention protruding portion is one of a linear protruding portion provided on the end surface of the head portion extending between opposite edges of the head portion and a protruding portion provided on opposite side portions of the peripheral surface of the head portion.

3. The bolt rotation prevention structure according to claim 2, wherein the case of the electrical junction box is made of plastic, and
the head portion of the bolt has a shape of a quadrangle.

4. The bolt rotation prevention structure according to claim 1, wherein the head portion of the bolt has a shape of one of a polygon, an ellipse and an oblong.

5. The bolt rotation prevention structure according to claim 1, wherein the rotation-prevention protruding portion is provided on the end surface of the head portion and is perpendicular to the axis of the bolt, and the positioning recess is provided on a bottom inner surface of the receiving portion.

6. The bolt rotation prevention structure according to claim 1, wherein the rotation-prevention protruding portion includes a pair of protrusions provided on opposite peripheral surfaces of the head portion, and the positioning recess includes a pair of recesses provided on opposite side inner surfaces of the receiving portion.
